(19) United States
(12) Patent Application Publication
(10) Pub. No.: US 2013/0206676 A1
(43) Pub. Date: Aug. 15, 2013

(54) MEASURING DEVICE HAVING A PRESSURE SENSOR

(71) Applicant: Rolls-Royce Deutschland Ltd & Co KG, (US)

(72) Inventors: Rudolf LUECK, Nuthetal Rehbruecke (DE); Peter HACKENBERG, Potsdam (DE)

(73) Assignee: ROLLS-ROYCE DEUTSCHLAND LTD & CO KG, Blankenfelde-Mahlow (DE)

(21) Appl. No.: 13/764,338

(22) Filed: Feb. 11, 2013

(30) Foreign Application Priority Data
Feb. 10, 2012 (DE) 10 2012 202 038.1

(51) Int. Cl. B01D 35/14; G01L 19/00

(52) U.S. Cl. CPC B01D 35/14; G01L 19/0007
USPC 210/348; 73/707

(57) ABSTRACT

The present invention relates to a measuring device having a pressure sensor, with the pressure sensor having a measuring cell designed to detect a pressure. It is provided that the measuring cell of the pressure sensor is arranged in or adjacent to a protective cell filled with a measuring fluid that can be coupled to a fluid to be measured via at least one separating membrane. It is furthermore provided that a damping device is arranged in the protective cell between the separating membrane and the measuring cell, said damping device including a restrictor and a downstream volume expansion means that provides an increased volume between the restrictor and the measuring cell in the event of a pressure increase in the measuring fluid.

### CROSS-REFERENCE TO RELATED APPLICATION

This application claims the benefit of German Patent Application No. 10 2012 202 038.1 filed on Feb. 10, 2012, the entirety of which is fully incorporated herein by reference.

### BACKGROUND

This invention relates to a measuring device having a pressure sensor and a filter arrangement for filtering a fluid with such a measuring device. The measuring device provides protection of a pressure sensor from pressure and shock waves.

The oil and fuel supply, for example in aircraft engines, is freed of impurities by filter arrangements. To check the flow through the filter arrangement and to detect stoppages early on, a differential pressure sensor, for example a pressure sensor based on an integrated chip (IC), is located parallel to the filter arrangement in a measuring conduit connected between the inlet and the outlet of the filter arrangement. This sensor consists of a semi-conductor membrane onto which strain gauges are diffused or etched. In the event of a pressure difference, the strain gauges are stretched or compressed, and a change in the electrical resistance takes place. This allows checking of the flow of oil and fuel and detection of stoppages in good time.

There is however a risk that pressure sensors having this design are damaged by a permanently oscillating pressure. Various devices are known to protect the differential pressure sensors from such events.

U.S. Pat. No. 5,157,973 describes a pressure sensor with integrated overpressure protection. The pressure sensor comprising a silicone membrane is enclosed by two housing halves each permitting the measurement of pressures or pressure differences through a conduit pipe. The silicone membrane includes of a central part that can move axially like a piston, as well as an outer part and a thin, flexible rod connecting the outer part and the inner part to one another. The inner parts of the housing halves each have a thin protective layer that presses against the central part of the silicone membrane in the event of overpressure and hence prevents any axial movement. The layer at the same time acts as a capacitor for measurement of the electrical resistance, allowing conclusions to be drawn about the magnitude of the prevailing pressure.

WO 96/03629 A1 describes a protective membrane for a silicon pressure sensor containing in its outer circumference a bead which absorbs the temperature and pressure stresses and also influences the inertia of the protective membrane.

US 200510081638 A1 describes a sensor diaphragm for a differential pressure sensor with overpressure protection. The differential pressure sensor consists here of a split housing. Between its two parts a membrane in the form of a multi-layer composite is provided that divides the intermediate space into two halves and curves in the direction of the lower pressure depending on the pressure difference. The inner housing is designed here such that it permits no further curvature of the membrane when the pressure is too high.

From U.S. Pat. No. 4,686,764 a semi-conductor pressure sensor protected by a membrane is already known, which measures the pressure using a combination of a pressure transfer medium and a thin protective membrane. The protective membrane is intended to protect the sensor from air entrapments and unusual fluctuations of the pressure.

A capacitive differential pressure sensor with overpressure protection is known from U.S. Pat. No. 4,879,627, which consists of two capacitive sensors arranged adjacent to one another and forming an intermediate space. In the event of pressure changes, the sensor membranes bend, and the capacitance alters. Although the dual design already offers protection against overpressure, the membranes are additionally safeguarded by a stop or a bearing.

DE 10 2010 022 642 A1 describes a device for checking the flow of oil or fuel through a filter arrangement, in which a differential pressure sensor is connected between two arms of a measuring conduit and a connecting line with a protective membrane is arranged parallel to the differential pressure sensor. With the protective membrane, a differential overpressure is compensated for and filtered out upstream of the actually measuring differential pressure sensor.

There is a need for further solutions providing protection for sensitive pressure sensors (including differential pressure sensors) from periodic pressure and shock waves, which can lead to a greatly reduced service life. A protection of this type is important, in particular for pressure sensors with sensitive microstructure elements and for applications where heavy vibrations and resonances can occur. For example, transmissions, in particular in aircraft engines, can suffer from heavy vibrations which can trigger greatly oscillating waves with high amplitudes. Pumps that convey liquids can also trigger heavy pressure waves. Furthermore, resonances can build up in different parts of a line, The consequence of these vibrations and resonances is that the measuring membrane of the measuring cell of a pressure sensor can be subjected to heavy periodic pressure pulsations, which can cause damage or even destruction of the measuring cell.

### SUMMARY

A broad aspect of the present Invention is to provide a measuring device having a pressure sensor, with the measuring device protecting the pressure sensor from the pressure and shock waves occurring.

To solve this problem, the invention provides a protective cell filled with a measuring fluid in which or adjacently to which the measuring cell of the pressure sensor is arranged. The measuring fluid of the protective cell can be coupled to a fluid to be measured via at least one separating membrane. The separating membrane represents to that extent a limitation of the protective cell. Furthermore, a damping device is arranged in accordance with the invention in the protective cell between the separating membrane and the measuring cell. The damping device includes a restricting structure, which represents a local flow resistance for the measuring fluid, and downstream thereof a volume expansion means which in the event of a pressure increase in the measuring fluid provides an increased volume between the restricting structure and the measuring cell.

The solution in accordance with the invention provides by means of the damping device a protective mechanism for the pressure sensor. This protective mechanism is designed in the form of a serial damper connected upstream of the measuring membrane of the measuring cell of the pressure sensor. The damping device or the serial damper, respectively, consists of a restricting structure, referred to hereinafter as a restrictor, and a volume expansion means fitted downstream of the restrictor and allowing an expansion for the measuring fluid.

The mode of operation of such a damping device is as follows. Periodic pressure fluctuations must pass the restrictor before they can reach the measuring membrane of the protective cell. This is achieved in that the volume expansion means downstream of the restrictor absorbs an increased volume from the increased pressure provided by the periodic pressure fluctuation. The provision of the volume expansion means thus permits a flow of the measuring fluid through the restrictor, resulting in a pressure drop due to the restrictor. This pressure drop prevents heavy periodic pressure fluctuations reaching the measuring cell.

In accordance with an embodiment of the invention, the damping device is furthermore arranged in a protective cell filled with a measuring fluid. The damping device is thus not directly placed in the supply lines to the measuring cell. This has the advantage that potentially contaminated liquids such as fuel or oil cannot block narrow passages of the restrictor. Instead, the damping device is located between a separating membrane and the measuring cell of the pressure sensor, where the intermediate space between the separating membrane and the measuring cell, referred to as the protective cell, is filled with a “pure” liquid.

By the arrangement of a damping device with a restrictor and a volume expansion means inside a protective cell, pressure surges upstream of the sensitive membrane of the measuring cell are thus damped. Hence the pressure sensor is also suitable for applications with high periodic pressure surges. Blockages or stoppages in the restrictor are also reliably prevented by the arrangement the damping device in a defined and clean liquid, the measuring fluid.

The restrictor can be provided by any structure effecting a restriction of the line cross-section in the protective cell and/or a diversion of the measuring fluid, and hence creating a flow resistance. The restrictor is for example formed by an open-pore porous structure. for example by an open-pore microstructure, which is for example a metal foam. The restrictor can have a plurality of constriction points for the measuring fluid that are arranged parallelly and/or serially, as is the case with a porous structure, for example. The restrictor can however also be designed in other ways, for example as a choke.

The volume expansion means can in a possible embodiment of the invention be formed by an elastically compressible and/or elastic element arranged between the restrictor and the measuring cell, When a pressure occurs, the volume expansion means undergoes a compression and/or an elastic deflection, so that t he volume increases in the area between the restrictor and the measuring cell.

The volume expansion means is for example designed as a compressible plastic element or is for example formed by compressible plastic balls. It can also be provided that the volume expansion means includes at least one elastic wall section of the protective cell provided in the area between the restrictor and the measuring cell, A pressure increase leads in this case to a deflection of the wall section and hence to a volume increase. An elastic wall section of this type can be provided by, for example, a plastic wall or an elastically mounted metal wall. However, other expansion variants are also possible.

The measuring fluid in the protective cell is for example a silicone oil, a mineral oil or water, with this measuring fluid forming a “pure” liquid of the measuring cell that is free of contamination.

The protective cell includes in an embodiment between the separating membrane and the restrictor a coupled volume. Pressure changes in the fluid to be measured, which is in contact with the separating membrane side facing away from the protective cell, are transmitted via the separating membrane to the measuring fluid in the protective cell, with the pressure change initially being absorbed in the coupled volume and then continuing in the direction of the damping device.

In accordance with an embodiment of the invention, the damping device of the measuring device in accordance with the invention is equipped and designed to damp periodic pressure fluctuations, in particular higher-frequency pressure fluctuations. Higher-frequency pressure fluctuations refer to pressure fluctuations with a frequency at least one decade higher than the frequencies in the measuring range to be detected. The solution in accordance with the invention filters out rapid pressure changes caused by periodic pressure fluctuations, so that the measuring cell is protected from such pressure changes. Slow pressure changes, for example in the range of a few Hz or below, or quasi-static pressure changes by contrast are not filtered out and are detected by the measuring cell.

In an embodiment of the invention, the pressure sensor is designed for measurement of an absolute pressure. The measuring cell of the pressure sensor is here adjacent on the one hand to the protective cell and on the other hand to a reference pressure provided for example by a comparative volume, designed for instance as a vacuum cell.

In another embodiment, the pressure sensor is designed as a differential pressure sensor, where the protective cell is designed symmetrical and has two separating membranes and two damping devices. The measuring cell of the pressure sensor is here arranged between the two damping devices. If a differential pressure sensor is used, the described protective mechanism thus has a dual use.

The invention also relates to a filter arrangement for filtering of a fluid with a device in accordance with an embodiment of the invention, where the device is connected in a measuring conduit with two measuring conduit arms between an inlet into the filter arrangement and an outlet from the filter arrangement, each connected by a separating membrane to the protective cell of the device. A filter arrangement of this type using a differential pressure sensor is for example used in fuel or oil lines or in lines with lubricant, in order to detect any blockage of the filter arrangement due to contamination, This is achieved by measurement of the static pressure or of a pressure drop due to the filter.

The device in accordance with the invention can be used for filtering periodic pressure fluctuations any liquids, gases and mixtures thereof. Its use in conjunction with a filter arrangement for filtering lubricant, oil or fuel represents only one embodiment of the invention.

A further advantage of the solution in accordance with the invention is that measuring cells manufactured using semi-conductor base material in microstructure technology, for example silicon measuring cells, can be used for the pressure sensor. The development and manufacture of these microstructure elements on a semi-conductor base material is expensive. It is therefore advantageous to use such structure elements in a modified form repeatedly for several different tasks, One such task can be its use in the measuring device in accordance with the invention, where protection for the measuring cell manufactured using microstructure technology is provided by the protective cell and the damping device.

The solution in accordance with the invention enables the service life of the measuring cell of the pressure sensor, usually designed in microstructure technology, to be prolonged such that its safe use is assured even when high periodic pressure waves occur. This makes microstructure elements developed in a complex and cost-intensive process suitable without alterations even for applications in pressure sensors where a tougher environment prevails with periodically occurring pressure pulses.

### BRIEF DESCRIPTION OF THE DRAWINGS

The present invention is explained in more detail in the following in light of the figures of the accompanying drawing, showing several embodiments

FIG. 1 shows a first embodiment of a measuring device having a pressure sensor and a damping device, with the measuring device being designed for absolute pressure measuring.

FIG. 2 shows a second embodiment of a measuring device having a pressure sensor, with the pressure sensor being designed as differential pressure sensor and the measuring device being designed symmetrical with two damping devices.

FIG. 3 schematically shows a filter arrangement in sectional view for filtering a fluid with a measuring device as per FIG. 2.

### DETAILED DESCRIPTION

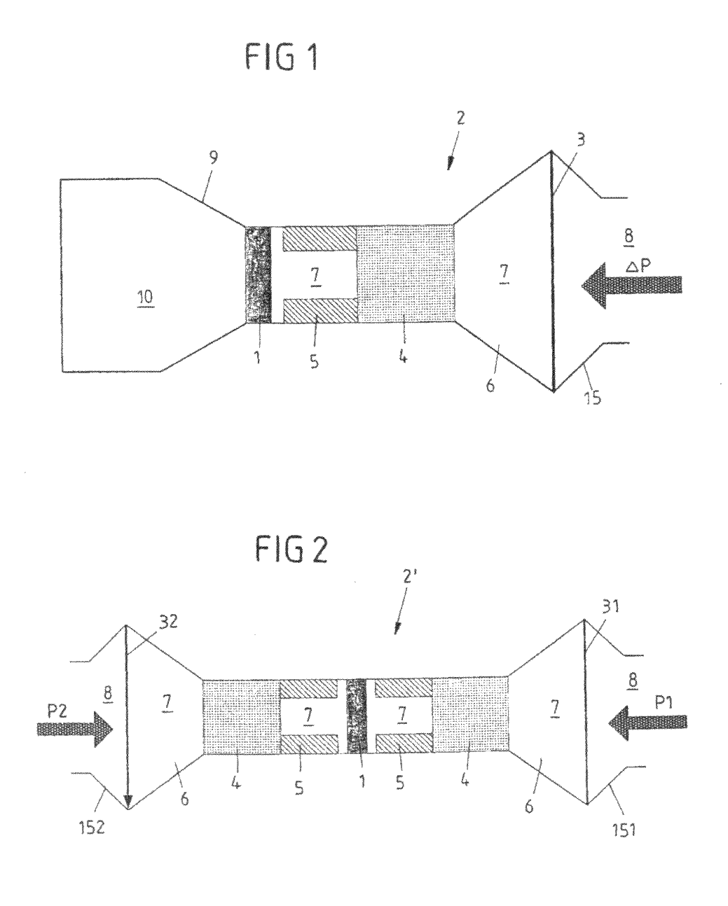

FIG. 1 shows a first embodiment of a measuring device including a measuring cell 1 of a pressure sensor and used to detect pressure changes of a fluid. The measuring cell is for example designed as a silicon measuring cell in microstructure technology. It typically includes in this case a structured silicon body and a measuring membrane. The membrane can be etched out of the silicon chip. Such measuring cells are known per se, so that they are not dealt with here, It is however pointed out that instead of measuring cells made of silicon any other measuring cells can be used that are suitable for measurement of a pressure. The pressure sensor can have additionally to the measuring cell 1 further elements, not shown, such as electrical and electronic components and connection contacts.

The measuring cell 1 is arranged at the edge of a protective cell 2 adjacent to the measuring cell 1 and having a separating membrane 3, a restrictor 4, a volume expansion means 5 and a coupled volume 8. The protective cell 2 is filled with a measuring fluid 7, which is for example a silicone oil. The protective cell 2 extends between the separating membrane 3 and the measuring cell 1.

On the other side of the separating membrane 3 there is a fluid 8 to be measured, in which a pressure p prevails. The fluid 8 to be measured is located for example in a tube-like supply line or measuring conduit 15. A pressure change Δp in the fluid 8 to be measured is transmitted via the separating membrane 3 to the measuring fluid 7 of the measuring cell 2. A pressure change of this type can in principle take place at low frequency or substantially statically, for which case it is detected and measured by the measuring cell 1. A pressure change of this type can however also take place at high frequency, with the occurrence of periodic pressure fluctuations possibly with a high amplitude. The measuring cell 1 must be protected from the latter pressure fluctuations in order to assure its long service life.

To do so, periodic pressure surges are damped by the combination of the restrictor 4 with the volume expansion means 5, as is explained in the following. The restrictor 4 and the volume expansion means provide here a damping device that protects the measuring cell 1 from periodic pressure fluctuations,

The restrictor 4 is formed in the embodiment shown by an open-pore microstructure, for example by a metal foam. The latter comprises a plurality of narrow passages and constriction points. A plurality of such constriction points can be provided parallel and/or sequentially in the restrictor 4.

The volume expansion means 5 is located between the restrictor 4 and the measuring cell 1. This means is for example formed by a plastic element, for example a plastic foam designed compressible yet elastic. In the event of a pressure increase, the volume expansion means 5 is elastically compressed, leading to a volume increase in the area between the restrictor 4 and the measuring cell 1. After the end of the pressure increase the volume expansion means 5 expands again.

According to another design variant, the volume expansion means 5 is formed by an elastic wall section of the measuring cell 2. In the event of a pressure increase, the elastic wall section expands, leading to an increase in the diameter of the measuring cell 2 in this area and hence also to a volume increase. The volume expansion means 5 can however also be provided in another way, for example by flexible metal structures or by compressible structures arranged inside the measuring fluid.

The volume expansion means 5 is designed in one embodiment such that its compressibility or elasticity is higher than that of the measuring membrane of the measuring cell 1, the latter thus having a greater stiffness. This ensures that the measuring membrane does not substantially contribute to the volume increase.

Damping in the event of the occurrence of periodic pressure surges in the fluid 8 to be measured takes place as follows. Pressure changes Δp in the fluid 8 to be measured are transmitted via the separating membrane 3 to the measuring fluid 7. The fluid absorbs the pressure change Δp in the coupled volume 6. The coupled volume 6 is designed in funnel shape in the embodiment shown, with its walls tapering in the direction of the restrictor 4. This embodiment of the coupled volume 6 is however to be understood only as an example, and is not necessary for operation of the measuring device.

It is provided in one design variant that the separating membrane 3 is dimensioned such that the necessary volume displacement can be assured without noteworthy material fatigue. The diameter of he separating membrane 3 can be selected relatively large in this connection.

The measuring fluid 7 absorbing the periodic pressure surges undergoes a pressure drop at the restrictor 4. It must be borne in mind here that a certain flow of the measuring fluid 7 through the restrictor 4 takes place, with the volume increase entailed by this flow in the area between the restrictor 4 and the measuring cell 1 being absorbed by the volume expansion means 5. The passage of measuring fluid 7 through the restrictor 4 results in a pressure drop due to the restrictor 4. This pressure drop prevents heavy periodic pressure fluctuations reaching the measuring cell 1. Low-frequency or quasi-static pressure changes can by contrast pass the damping device 4, 5 and are detected by the measuring cell 1.

On the side of the measuring cell 1 facing away from the protective cell 2 a reference cell 9 is provided, in which for example a vacuum 10 prevails. The reference cell 9 is coupled to the rear face of the measuring membrane of the measuring cell 1, so that pressure fluctuations in the fluid 8 to be measured can be detected and measured by the measuring device as absolute values.

FIG. 2 represents an embodiment in which the pressure sensor is designed as a differential pressure sensor. The measuring cell 2′ is in this embodiment designed symmetrical and includes two separating membranes 31, 32, two coupled volumes 6, two restrictors 4 and two volume expansion means 5, which are each arranged symmetrically relative to the centrally arranged measuring cell 1,

The fluid 8 to be measured is routed in two supply lines 151, 152 and coupled by one of the separating membranes 31, 32 respectively to the protective cell and the measuring fluid 7 present there. Depending on the design of the pressure sensor as a differential pressure sensor, low-frequency or quasi-static pressure differences between the pressures P1, P2 in the two feed lines 151, 152 are detected.

In the case of periodic pressure fluctuations, the filtering of these pressure fluctuations takes place on both sides of the measuring cell 1, as described with reference to FIG. 1.

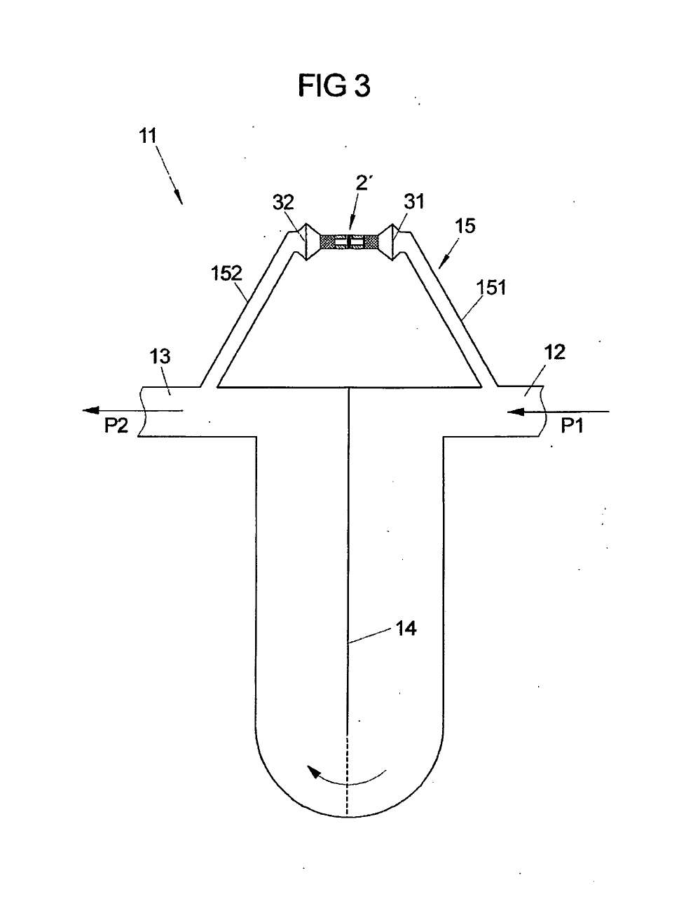

A use of the measuring device in FIG, 2 is described in FIG. 3, which represents a filter arrangement 11 for filtering oil or fuel, as used for example in aircraft engines. The filter arrangement 11 includes an inlet 12 for unfiltered oil or unfiltered fuel and an outlet 3 for the filtered oil or the filtered fuel. A filter element 14 is provided in the filter arrangement 11 in a manner known per se. The filter arrangement 11 is used for filtering foreign bodies or contaminants in oil or fuel.

The oil or the fuel flows to the filter arrangement 11 under the pressure P1 through the inlet 12 and leaves the filter arrangement 11 through the outlet 13 under the pressure P2. The differential pressure ΔP=P1−P2 obtained from the flow of the oil or fuel through the filter arrangement 11 must be continually measured and checked for timely detection of stoppages in the filter arrangement 11. At the same time, a pressure sensor performing this measurement and check must be protected from periodic pressure waves.

To do so, a measuring conduit 15 formed by a first and a second measuring conduit arm 151 152 is connected between the inlet 12 and the outlet 13 of the filter arrangement 11. The measuring arrangement according to FIG. 2 is connected between the two measuring conduit arms 151, 152. Accordingly, the one measuring conduit arm 151 is connected to the one separating membrane 31 and the other measuring conduit arm 152 to the other separating membrane 52. The protective cell 2′ with the two damping devices 4, 5 and the measuring cell 1 is located between the separating membranes 31, 32.

Thanks to the measuring arrangement described, a change of the pressure difference ΔP=P1−P2 can be detected, so that a stoppage can be recognized in good time. At the same time, the measuring cell of the pressure sensor is protected by the damping devices 4, 5 from periodic pressure fluctuations resulting for example from transmission vibrations and resonances. The pressure sensor is thus protected from occurring pressure waves and shock waves, so that it can perform its duties regarding measurement of the pressure difference ΔP with an extended service life.

The present invention is not limited in its design to the embodiments presented above, which are merely to be understood as examples. The protective cell, the restrictor and the volume expansion structure can for instance be designed in other ways than that shown. It can also be provided that the restrictor and the volume expansion structure do not directly follow one another, but are designed at a distance to one another between the separating membrane and the measuring cell

1. A measuring device having a pressure sensor, with the pressure sensor having a measuring cell designed to detect a pressure, wherein
the measuring cell of the pressure sensor is arranged in or adjacent to a protective cell filled with a measuring fluid that can be coupled to a fluid to be measured via at least one separating membrane, and
a damping device is arranged in the protective cell between the separating membrane and the measuring cell, said damping device including a restrictor and a downstream volume expansion means that provides an increased volume between the restrictor and the measuring cell in the event of a pressure increase in the measuring fluid.

2. The device in accordance with claim 1, wherein the restrictor is formed by an open-pore porous structure.

3. The device in accordance with claim 1, wherein the restricted is formed by metal foam.

4. The device in accordance with claim 1, wherein the restrictor has a plurality of constriction points for the measuring fluid that are arranged parallelly and/or serially.

5. The device in accordance with claim 1, wherein the volume expansion means has at least one elastically compressible and/or elastic element arranged between the restrictor and the measuring cell.

6. The device in accordance with claim 1, wherein the volume expansion means includes at least one elastic wall section of the protective cell provided in the area between the restrictor and the measuring cell.

7. The device in accordance with claim 1, wherein the measuring fluid is a silicone oil, a mineral oil or water.

8. The device in accordance with claim 1, wherein the measuring fluid is separated from the fluid to be measured, so that contamination of the measuring fluid is excluded.

9. The device in accordance with claim 1, wherein the protective cell coupled volume between the separating membrane and the restrictor.

10. The device in accordance with claim 1, wherein the damping device is equipped and designed to damp periodic pressure fluctuations, in particular pressure fluctuations in higher frequency ranges.

11. The device in accordance with claim 1, wherein the pressure sensor is designed for measurement of an absolute pressure, with the measuring cell of the pressure sensor being adjacent on the one hand to the protective cell and on the other hand to a reference pressure.

12. the device in accordance with claim 1, wherein the pressure sensor is designed as a differential pressure sensor, where the protective cell is designed symmetrical and has two separating membranes and two damping devices, with the measuring cell of the pressure sensor being arranged between the two damping devices.

13. A filter arrangement for filtering of a fluid comprising a device in accordance with claim 12, where the device is connected in a measuring conduit with two measuring conduit arms between an inlet into the filter arrangement and an outlet from the filter arrangement, each connected by a separating membrane to the protective cell f the device.

14. The filter arrangement in accordance with claim 3, wherein the filter arrangement is designed for filtering lubricant, oil or fuel.
